(19) United States
(12) Patent Application Publication
(10) Pub. No.: US 2019/0293456 A1
(43) Pub. Date: Sep. 26, 2019

(54) CAPACITIVE SENSING SYSTEM FOR THE DETECTION OF FOOD PRODUCTS DISPOSED WITHIN A FOOD WARMING TRAY OR FOOD STORAGE CONTAINER

(71) Applicant: A. J. ANTUNES & CO., Carol Stream, IL (US)

(72) Inventors: WILLIAM BRACH, Cary, IL (US); JAMES BUCHLER, Orland Park, IL (US)

(21) Appl. No.: 16/358,857

(22) Filed: Mar. 20, 2019

Related U.S. Application Data
(60) Provisional application No. 62/647,803, filed on Mar. 25, 2018.

(51) Int. Cl. G01D 5/24; A47G 19/02; G06Q 10/08

(52) U.S. Cl. CPC G01D 5/24; G06Q 10/087; A47G 19/027

(57) ABSTRACT

A capacitive sensing system for the detection and quantification of food products disposed within a food warming drawer or food storage container is disclosed and comprises an electrically grounded metal plate, and a printed circuit board (PCB) having a plurality of capacitive sensing pads disposed thereon and which effectively serve as capacitive sensors capable of detecting and measuring the capacitance of an object in proximity to it. The system, in conjunction with known detection circuitry, outputs or generates digital number signals which are indicative of the capacitance of the items or food products disposed within the food warming drawer or storage container. The system can therefore be utilized to detect the presence and number of food items disposed within the food warming drawer or container, as well as whether or not the food items are disposed within a vertically stacked array or disposed in a side-by-side array. The system is adapted to be utilized within the food industry as a means for knowing how many food items are present and ready to be used to fulfill patron food orders.

### CROSS-REFERENCE TO RELATED PATENT APPLICATIONS

This patent application is a non-provisional patent application conversion of a provisional patent application which was filed on Mar. 25, 2018 and which was granted application No. 62/647,803. This non-provisional patent application claims the priority benefits of the aforenoted provisional patent application.

### FIELD OF THE INVENTION

The present invention relates generally to food service equipment, and more particularly to a new and improved capacitive sensing system for the detection of food products, the number of food products, and the location of the food products, within, for example, a food storage container, wherein the capacitive sensing system is a component part of an overall food service equipment system utilized within food establishments so as to enable food preparation personnel to know if any food products are in fact disposed within, for example, a food warming tray, or a food storage container, as well as the number of food products disposed within the food warming tray or food storage container, whereby a sufficient number of prepared food products or items will always be available in order to quickly and sufficiently fulfill pending food orders submitted by patrons of the food establishment.

### BACKGROUND OF THE INVENTION

In the food service industry, prepared food items are often placed within food warming drawers or other food storage containers so as to maintain the prepared food items warm while the food items are waiting to be used by food service personnel in connection with the fulfillment of patron food orders. In connection with such stored food items, it is often desired to know how many food items are in fact disposed within the food warming drawer or other food storage container such that service personnel can in fact be assured that a sufficient number of particular food items have in fact been prepared in order to satisfactorily fulfill patron food orders within a predeterminedly desired period of time. In order to achieve such operations, a plurality of conventional means or techniques have been employed. For example, an entirely manual system comprises a food service employee would simply open the food warming drawer or other food storage container and count the number of items contained within the food warming drawer or other food storage container. Obviously, this method or technique is labor intensive and time-consuming. Another method or system comprises the use of a plurality of cameras located at strategic positions in and around the food preparation area so as to visually monitor the preparation and storage of the prepared food items, however, it has been noted that cameras are sensitive to heat, which can shorten their service lives. In addition, cameras are expensive. Still another method or system involves the use of ultrasonic sensing equipment, however, such equipment depends upon air transducers and it is known that air density varies with temperature. Hence, these systems have not proved to be sufficiently reliable, whereby erratic sensing outputs can result. In addition, high temperature environments can sometimes damage transducers.

A need therefore exists in the art for a new and improved sensing system. Another needs exists in the art for a new and improved sensing system which is adaptable for sensing food items. Still another need exists in the art for a new and improved sensing system which is adaptable for sensing food items and which may be utilized in the food service industry. Yet another need exists in the art for a new and improved sensing system which is adaptable for sensing food items and which may be utilized within the food service industry in order to detect the presence and number of food items disposed within, for example, a food warming drawer or similar food storage container in preparation for the fulfillment of patron food orders. Yet still another need exists in the art for a new and improved sensing system which is adaptable for sensing food items, which may be utilized within the food service industry in order to detect the presence and number of food items disposed within, for example, a food warming drawer or similar food storage container in preparation for the fulfillment of patron food orders, and which can accomplish this goal regardless of whether the food items are disposed within the food warming drawer or other food storage container in a side-by-side manner or stacked atop one another.

### Overall Objectives of the Invention

An overall objective of the present invention is to provide a new and improved sensing system. Another overall objective of the present invention is to provide a new and improved sensing system which is adaptable for sensing food items. Still another overall objective of the present invention is to provide a new and improved sensing system which is adaptable for sensing food items and which may be utilized in the food service industry. Yet another overall objective of the present invention is to provide a new and improved sensing system which is adaptable for sensing food items and which may be utilized within the food service industry in order to detect the presence and number of food items disposed within, for example, a food warming drawer or similar food storage container in preparation for the fulfillment of patron food orders. Yet still another overall objective of the present invention is to provide a new and improved sensing system which is adaptable for sensing food items, which may be utilized within the food service industry in order to detect the presence and number of food items disposed within, for example, a food warming drawer or similar food storage container in preparation for the fulfillment of patron food orders, and which can accomplish this goal regardless of whether the food items are disposed within the food warming drawer or other food storage container in a side-by-side manner or stacked atop one another.

### SUMMARY OF THE INVENTION

The foregoing and other objectives are achieved in accordance with the new and improved sensing system, developed in accordance with the principles and teachings of the present invention, wherein there is provided, for example, a rectangularly configured printed circuit board (PCB) which has a plurality of rectangularly configured capacitive sensing pads etched onto an interior surface thereof, that is, upon the surface which effectively faces, or is oriented toward, the food items to be sensed and measured. The plurality of rectangularly configured capacitive sensing pads are disposed parallel to each other and are disposed, within a linear array, adjacent to one another such that each one of the plurality of rectangularly configured capacitive sensing pads has its oppositely disposed, short sides disposed opposite and adjacent to the long sides of the rectangularly configured printed circuit board (PCB), while the oppositely disposed, long sides of the two rectangularly configured capacitive sensing pads, disposed upon opposite ends of the linear array of the plurality of rectangularly configured capacitive sensing pads, are disposed parallel to the short sides of the printed circuit board (PCB). The food items are disposed upon an electrically grounded metal plate whereby the electrically grounded metal plate effectively cooperates with the plurality of capacitive sensing pads, which are disposed upon the printed circuit board (PCB) and effectively define capacitive sensors, so as to define with the plurality of capacitive sensing pads capacitive coupling circuits which can effectively detect the presence of items, the size of the items, and the location of the items, which are effectively located at positions interposed between the plurality of capacitive sensing pads and the electrically grounded metal plate, as a result of detecting and measuring the capacitance of the objects in proximity to each one of the plurality of capacitive sensing pads. The plurality of capacitive sensing pads can be fabricated from a variety of materials, such as, for example, copper, indium tin oxide (ITO), electrically conductive composites, and printed ink.

In operation, the system, in conjunction with known detection circuitry, outputs digital numbers, one per capacitive sensor, which represents the capacitance of the objects in proximity to each one of the plurality of capacitive sensing pads. Therefore, by utilizing a sufficient number of capacitive sensors, a multiplicity of food products can be detected and counted, regardless of whether the food products are disposed in a side-by-side array with respect to each other, or stacked one atop another. The digital numbers outputted by means of the system may be represented as a waveform from which the data may be analyzed by means of a suitable software algorithm so as to yield the number of food items, their size or thickness dimensions, and their locations within the food warming tray or food storage container. This information can then be transmitted to food preparation personnel by any one of various different means, such as, for example, wireless communication, whereby the food preparation personnel would then know what food products are disposed within the food warming tray or food storage container, how many food products are disposed within the food warming tray or food storage container, and the like, without the necessity of such food preparation personnel opening the food warming tray or food storage container and actually viewing and counting the prepared food products. It is lastly noted that the printed circuit board (PCB) can be a relatively hard or rigid board, or alternatively, the printed circuit board (PCB) can be a relatively flexible printed circuit board (PCB) so as to enable the system of the present invention to be utilized within additional environments as may be necessary.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic view the new and improved capacitive sensing system, as developed in accordance with the principles and teachings of the present invention, which may be employed for detecting or determining the presence of various objects, such as, for example, food products, their size, their number, and their location within a food warming tray or food storage container, by detecting and measuring the capacitance of the food products which are disposed within a predetermined proximity to a printed circuit board having a plurality of capacitive sensing pads formed thereon; and

FIG. 2 is a schematic view of the printed circuit board having the plurality of capacitive sensing pads disposed thereon which effectively define a plurality of capacitive sensors wherein each sensor will emit a signal, in the form of a digital number, representing the capacitance of the food product within its vicinity or proximity whereby the food products, and their number, can be detected and counted, regardless of whether the food items are disposed in a side-by-side array with respect to each other, or are disposed within a stacked array wherein the food items are disposed one atop another.

### DETAILED DESCRIPTION OF THE PREFERRED EMBODIMENT

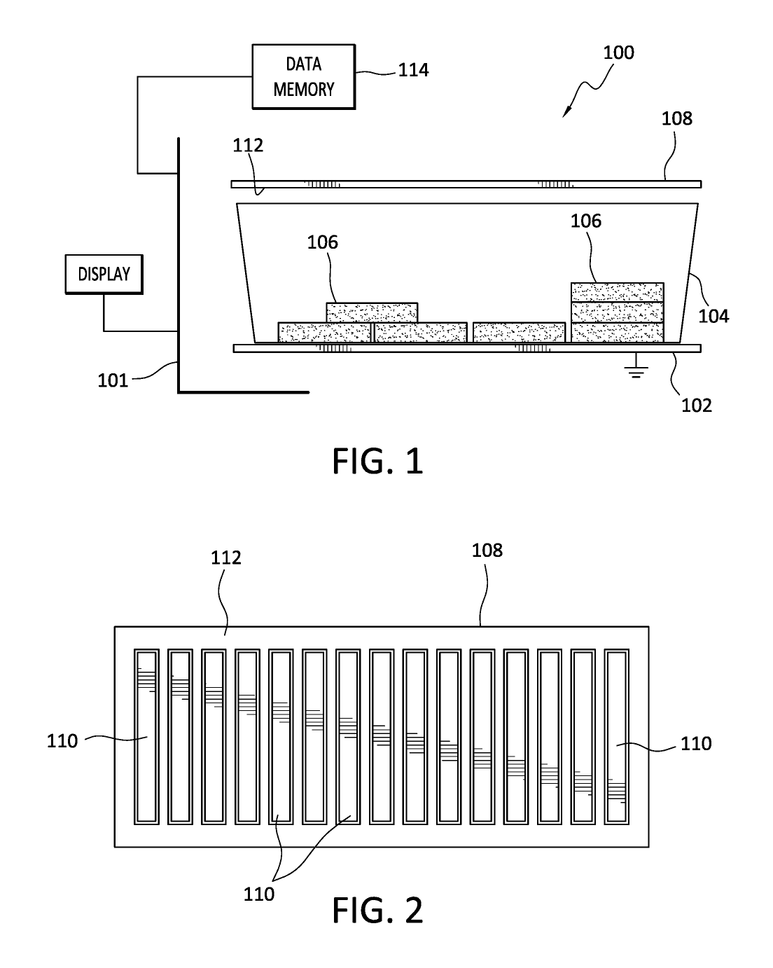

Referring now to the drawings, and more particularly to FIGS. 1 and 2 thereof, a new and improved capacitive sensing system, developed in accordance with the principles and teachings of the present invention, and is intended to be utilized in connection with the detecting and measuring the capacitance of, for example, food products disposed within a food warming tray or a food storage container, is disclosed and is generally indicated by the reference character 100. More particularly, as can best be seen or appreciated from FIG. 1, the new and improved capacitive sensing system 100 is adapted to be disposed within a warming drawer or food product storage container disposed within, or adjacent to, food cooking apparatus or equipment 101 and is seen to comprise an electrically grounded metal plate 102, which effectively serves as a floor or bottom wall of a food warming tray or food storage container 104 within which a plurality of food items 106 are disposed, and a printed circuit board (PCB) 108 having a plurality of capacitive sensing pads 110 etched thereon as seen in FIG. 2.

With reference being made to FIG. 2, it is seen that the printed circuit board (PCB) 108 comprises, for example, a rectangularly configured printed circuit board (PCB) 108 which has a plurality of rectangularly configured capacitive sensing pads 110 etched onto an interior surface 112 of the printed circuit board (PCB) 108, that is, upon the surface which effectively faces, or is oriented toward, the food items 106 to be sensed and measured. The plurality of rectangularly configured capacitive sensing pads 110 are disposed parallel to each other and are disposed, within a linear array, adjacent to one another such that each one of the plurality of rectangularly configured capacitive sensing pads 110 has its oppositely disposed, short sides disposed opposite to, and adjacent to, the long sides of the rectangularly configured printed circuit board (PCB) 108, while the oppositely disposed, long sides of the two rectangularly configured capacitive sensing pads 110, disposed upon opposite ends of the linear array of the plurality of rectangularly configured capacitive sensing pads 110, are disposed parallel to the short sides of the printed circuit board (PCB) 108.

Reverting back to FIG. 1, it is seen that the food items 106 are disposed upon the electrically grounded metal plate 102 whereby the electrically grounded metal plate 102 effectively cooperates with the plurality of capacitive sensing pads 110, which are disposed upon the printed circuit board (PCB) 108 and effectively define capacitive sensors, so as to define with the plurality of capacitive sensing pads 110, capacitive coupling circuits which can effectively detect the presence of items, the size of the items, and the location of the items, which are effectively located at positions interposed between the plurality of capacitive sensing pads 110 and the electrically grounded metal plate 102, as a result of detecting and measuring the capacitance of the objects in proximity to each one of the plurality of capacitive sensing pads 110. The plurality of capacitive sensing pads can be fabricated from a variety of materials, such as, for example, copper, indium tin oxide (ITO), electrically conductive composites, and printed ink. In addition, it is to be noted that a data memory 114 is operatively associated with the food cooking apparatus or equipment 101, or alternatively with the food warming tray or food storage container 104, whereby predetermined capacitance levels, characteristic of individually different cooked food items, such as, for example, hamburgers, French fries, pancakes, egg breakfast sandwiches, and the like, are stored as base capacitance levels indicative of the individual food items. Still further, a display 116, likewise operatively associated with the food cooking apparatus or equipment 101, or alternatively with the food warming tray or food storage container 104, is provided so as to display to food order or service personnel the number of food items 106 disposed within the food warming tray or food storage container 104.

Having described substantially all of the structural components comprising the new and improved capacitive sensing system 100 of the present invention, the operation of the same will now be briefly described. More particularly, in operation, when one or more foods items 106 are disposed within the food warming drawer or food storage container 104, and the system 100 is activated, the system 100, in conjunction with known detection circuitry, will output digital numbers, one per capacitive sensor or capacitive sensing pad 110, which respectively represent the capacitance of the object or objects in proximity to each one of the plurality of capacitive sensing pads 110 in accordance with the stored capacitance data within memory 114 which is indicative of the capacitance of a particular food item 106. Therefore, by utilizing a sufficient number of capacitive sensors or sensing pads 110, a multiplicity of food products 106 can be detected and counted, regardless of whether the food products 106 are disposed in a side-by-side array with respect to each other, as illustrated within the left side portion of FIG. 1, or stacked atop one another as illustrated within the right side portion of FIG. 1. The digital numbers outputted by means of the system 100 may then be represented as a waveform from which the data may be analyzed by means of a suitable software algorithm so as to yield the number of food items 106, their size or thickness dimensions, and their locations within the food warming tray or food storage container 104. The number of food items 106 detected is then displayed to food order or food service personnel upon the display 116. It is lastly noted that the printed circuit board (PCB) 108 can be a relatively hard or rigid board, or alternatively, the printed circuit board (PCB) can be a relatively flexible printed circuit board (PCB) so as to enable the system of the present invention to be utilized within additional environments as may be necessary. For example, a flexible printed circuit board (PCB) 108, having the plurality of capacitive sensing pads 110 mounted or defined thereon, could effectively be wrapped around a tubular pipe which is closed at both ends, and yet, objects disposed internally of the tubular pipe could be detected and quantified.

Obviously, many variations and modifications of the present invention are possible in light of the above teachings. It is therefore to be understood that within the scope of the appended claims, the present invention may be practiced otherwise than as specifically described herein.

### REFERENCE NUMBER KEY

100—Capacitive sensing system
102—Electrically grounded metal plate
104—Food warming tray or food storage container
106—Food items disposed within the food warming tray or food container
108—Printed circuit board
110—Plurality of capacitive sensing pads disposed upon printed circuit board
112—Interior surface of printed circuit board
114—Memory of system 100
116—Display of system 100

What is claimed as new and desired to be protected by Letters Patent, is:

1. A capacitive sensing system for detecting and quantifying the presence of items, comprising:
an electrically grounded metal plate;
a printed circuit board; and
a plurality of capacitive sensing pads, disposed upon a surface portion of said printed circuit board which faces, or is disposed toward, the items to be detected and quantified, so as to define, together with said electrically grounded metal plate, a capacitive sensing system which is capable of measuring the capacitance of one or more items in proximity to said plurality of capacitive sensing pads and thereby detect the presence of the one or more items and to quantify the number and size of the one or more items.

2. The system as set forth in claim 1, wherein:
the items comprise food items.

3. The system as set forth in claim 2, wherein:
the items comprise food items which are disposed within a food storage container.

4. The system as set forth in claim 3, wherein:
said food storage container comprises a food warming drawer or food warming tray for maintaining the food items warm while patron food orders are processed and fulfilled.

5. The system as set forth in claim 1, wherein:
each one of said plurality of capacitive sensing pads outputs a signal, in the form of a digital number, which is representative of the capacitance of the item which is in the proximity of one or more of said plurality of capacitive sensing pads,
whereby the presence of the item, as well as its size or dimensions, can be determined as a result of said signal outputs from said plurality of capacitive sensing pads.

6. The system as set forth in claim 5, wherein:
said plurality of capacitive sensing pads can detect the presence, size, and thickness dimensions of the items when the items are disposed within a side-by-side array.

7. The system as set forth in claim 5, wherein:
said plurality of capacitive sensing pads can detect the presence, size, and thickness dimensions of the items when the items are disposed within a vertically stacked array.

8. The system as set forth in claim 1, wherein:
said plurality of capacitive sensing pads are fabricated from a material selected from the group comprising copper, indium tin oxide (ITO), electrically conductive composites, and printed ink.

9. The system as set forth in claim 1, further comprising:
a memory for storing therein predetermined capacitance levels indicative of different items such that when capacitance levels are detected by said capacitive sensing system, the number, size, and location of the items can be detected and quantified by said system.

10. The system as set forth in claim 1, further comprising:
a display for displaying to food order or food service personnel the number of items detected.

11. Food equipment having a capacitive sensing system incorporated therein for detecting and quantifying the presence of items, wherein said system comprises:
an electrically grounded metal plate;
a printed circuit board; and
a plurality of capacitive sensing pads, disposed upon a surface portion of said printed circuit board which faces, or is disposed toward, the items to be detected and quantified, so as to define, together with said electrically grounded metal plate, a capacitive sensing system which is capable of measuring the capacitance of one or more items in proximity to said plurality of capacitive sensing pads and thereby detect the presence of the one or more items and to quantify the number and size of the one or more items.

12. The equipment as set forth in claim 11, wherein:
the items comprise food items.

13. The equipment as set forth in claim 12, wherein:
the items comprise food items which are disposed within a food storage container.

14. The equipment as set forth in claim 13, wherein:
said food storage container comprises a food warming drawer or food warming tray for maintaining the food items warm while patron food orders are processed and fulfilled.

15. The equipment as set forth in claim 11, wherein:
each one of said plurality of capacitive sensing pads outputs a signal, in the form of a digital number, which is representative of the capacitance of the item which is in the proximity of one or more of said plurality of capacitive sensing pads,
whereby the presence of the item, as well as its size or dimensions, can be determined as a result of said signal outputs from said plurality of capacitive sensing pads.

16. The equipment as set forth in claim 15, wherein:
said plurality of capacitive sensing pads can detect the presence, size, and thickness dimensions of the items when the items are disposed within a side-by-side array.

17. The equipment as set forth in claim 15, wherein:
said plurality of capacitive sensing pads can detect the presence, size, and thickness dimensions of the items when the items are disposed within a vertically stacked array.

18. The equipment as set forth in claim 11, wherein:
said plurality of capacitive sensing pads are fabricated from a material selected from the group comprising copper, indium tin oxide (ITO), electrically conductive composites, and printed ink.

19. The equipment as set forth in claim 11, further comprising:
a memory for storing therein predetermined capacitance levels indicative of different items such that when capacitance levels are detected by said capacitive sensing system, the number, size, and location of the items can be detected and quantified by said system.

20. The equipment as set forth in claim 11, further comprising:
a display for displaying to food order or food service personnel the number of items detected.
